(19) United States
(12) Patent Application Publication
(10) Pub. No.: US 2011/0244162 A1
(43) Pub. Date: Oct. 6, 2011

(54) PRICE REDUCTION LABEL AND PRICE REDUCTION LABEL APPLYING METHOD

(76) Inventor: Satoru Honda, Tokyo (JP)

(21) Appl. No.: 12/529,411

(22) PCT Filed: Oct. 30, 2008
(86) PCT No.: PCT/JP2008/069721

§ 371 Date: Sep. 1, 2009

(30) Foreign Application Priority Data
Aug. 22, 2008 (JP) 2008-214495

(51) Int. Cl. B32B 7/12

(52) U.S. Cl. 428/42.2

(57) ABSTRACT

A price reduction label includes: a label body, an adhesive material coated on the back surface of the label body in spaced and strip-shape plural rows, a release material coated on the upper surface of the label body in opposing region of the adhesive material, an adhesive region coated with the adhesive material and a non-adhesive region without the adhesive material formed alternately in the width direction perpendicular to the strip direction of the strip of adhesive material on the back surface of the label body, and a release region A coated with release material and a non-release region without the release material formed alternately in the width direction of the upper surface of the label body, and the first tamper-resistant slits and the second tamper-resistant slits formed on the adhesive region of the label body.

### CROSS REFERENCE TO RELATED APPLICATION

The present application is a 35 U.S.C. §§371 national phase conversion of PCT/JP2008/069721, filed Oct. 30, 2008, which claims priority of Japanese Application No. 2008-214495, filed Aug. 22, 2008, the disclosure of which is incorporated by reference herein. The PCT International Application was published in the Japanese language.

### BACKGROUND OF THE INVENTION

1. Technical Field

The present invention relates to a label to be applied, with the preferred embodiment of a price reduction label applied over the price indication of articles, such as commercial products, indicating a new price, and also the applying method thereof.

2. Background Art

In price reduction labels indicating a new price which are applied over price indications of articles, such as commercial goods, so called a “tamper-resistant slit” or re-application preventing slits are formed. Once the price reduction label has been applied and removed afterwards, the label is torn at the tamper-resistant slit to prevent its reuse. Generally, the price reduction labels with such tamper-resistant slits are temporally applied to a backing paper and are later released from the backing paper when used.

The invention proposes coating a release material onto the upper surface of the price reduction labels, winding it in a roll, and using those labels without a backing paper.

In use, price reduction labels are applied on top of each other if the price on the item is changed several times. In the conventional art, however, as the entire upper surface of the price reduction label is coated with the release material, a price reduction label applied on top of another may be removed without being torn at the tamper-resistant slits. There is a risk that the removed price reduction label may be reused.
See Patent Document 1: Japanese Patent Application Laid Open No. 2002-14619

### SUMMARY OF INVENTION

### Technical Problem

The present invention concerns solving these problems. Accordingly, it is an object of the present invention to provide a price reduction label and an applying method for the price reduction label, which label can be used without a backing paper, such that even if one such label is applied on top of another, the label being removed is infallibly torn at the tamper-resistant slits, preventing the reuse of a removed label. Another object is to provide a label and method of its application for any type of label, not only one for price reduction.

### Solution to Problem

To achieve the above-mentioned object, the present invention concerns a price reduction label to be applied over a price indication displayed on an article in order to display a new price, wherein the price reduction label comprises the following elements. An upper surface serves as an indication surface of a new price. A back surface serves as an applying surface to be applied to the article. An adhesive material is coated on the back surface of the label body in spaced and strip-shape plural rows. A release material is coated on the upper surface of the label body in an opposing region of the adhesive material on the back surface. An adhesive region coated with adhesive material and a non-adhesive region without the adhesive material are formed alternately in the width direction perpendicular to the strip direction of adhesive material on the back surface of the label body. A release region coated with release material and a non-release region without the release material coating are formed alternately in the width direction on the upper surface of the label body. A re-application preventing slit is formed on the adhesive region of the label body. The non-releasable region of the label body includes a re-application preventing slit.

The label body is provided with a mark indicating the location of the release region.

The invention concerns a method of applying price reduction labels one on top of the other. A new price reduction label applied over the price reduction label on the article is shifted in the width direction of the label for the release region width and applied thereto, such that the adhesive region of the new price reduction label is applied over the non-release region of the price reduction label on the article.

### Advantageous Effects of Invention

The price reduction label of the present invention is provided with an upper surface serving as an indication surface of the new price and a back surface serving as an applying surface applied to the article. An adhesive material is coated on the back surface of the label body in spaced and strip-shape plural rows. A release material is coated on the upper surface of the label body in opposing region of the adhesive material of the back surface. An adhesive region coated with the adhesive material and a non-adhesive region without the adhesive material are formed alternately in the width direction perpendicular to the strip direction of adhesive material on the back surface of the label body. A release region coated with release material and a non-release region without the release material are formed alternately in the width direction of the upper surface of the label body. A re-application preventing slit is formed on the adhesive region of the label body. Upon winding the label body, with the upper surface of the label body on the outside, in a roll as a continuous label strip connecting in the strip direction of the adhesive material, the adhesive material applied on the back surface of the label body which is wound outwardly is temporarily applied to the release material coated on the upper surface of the label body, such that the label can be used without a backing paper. When applying one label on top of the other, by shifting the label in the width direction of the price reduction label for the release region width, the adhesive region of the new price reduction label with re-application preventing slits formed thereto is applied to the non-release region of the already applied price reduction label or to the articles. Therefore, even if a price reduction label is applied on top of the other, when the price reduction label is removed, the removed label is infallibly torn by the re-application preventing slits preventing reuse of the label.

In addition, when applying one label on top of the other, by forming the re-application preventing slits in the label body at the non-release region and by shifting the label in the width direction of the price reduction label for the release region width and applying the new price reduction label, the adhesive region of the new price reduction label is applied to the non-release region of the already applied label formed with the re-application preventing slits. Therefore, when removing the new price reduction label, the already applied price reduction label is torn by the re-application preventing slits, resulting in leaving traces of the removed label.

Further, by providing the label body with a mark indicating the location of the release region, this achieves an effect of easily understanding how much to shift the label when applying the label on top of the other.

### BRIEF DESCRIPTION OF THE DRAWINGS

FIGS. 1A, 1B and 1C are diagrams of the configuration of an embodiment related to the price reduction label of the present invention, of which 1A is a surface diagram, 1B is a side view diagram, and 1C is a back surface diagram.

FIGS. 2A, 2B, 2C and 2D are surface diagrams of other examples of the shapes of the tamper-resistant slits shown in FIGS. 1A to 1C.

FIGS. 3A and 3B are diagrams illustrating an embodiment of the price reduction label wound in a roll, of which 3A is a perspective view, and 3B is a drawing describing the price reduction labels in a layered state.

FIGS. 4A and 4B are diagrams describing the applying method of the price reduction label shown in FIGS. 1A to 1C to an article.

FIGS. 5A and 5B are diagrams describing the applying method of the price reduction label by applying the label on top of the other shown in FIGS. 1A to 1C.

FIGS. 6A and 6B are surface side diagrams illustrating the examples of the marks for applying the price reduction label on top of the other shown in FIGS. 1A to 1C.

### DESCRIPTION OF THE EMBODIMENTS

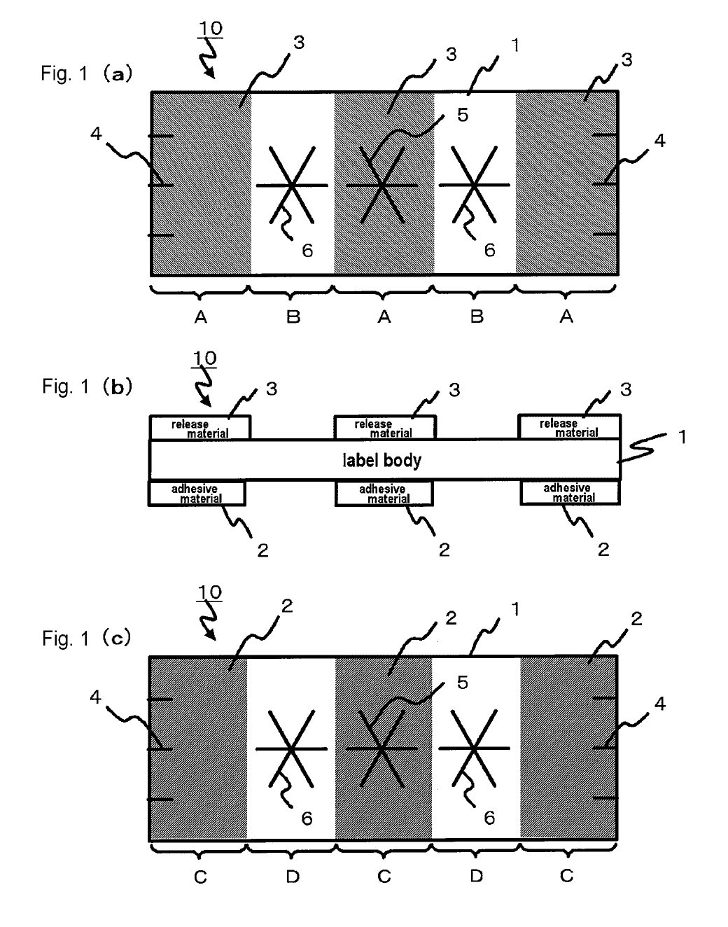

A price reduction label 10 according to an embodiment hereof is a rectangular label which indicates a new reduced price and is applied directly to an article such as commercial goods, or is applied over a price indicated by labels, etc. Referring to FIGS. 1A, 1B and 1C, the price reduction label 10 includes a rectangular label body 1. An adhesive material 2 is coated in stripes, that is, in spaced and strip-shaped plural rows on the back surface of the label body 1, which is the applying surface applied to the article. A release material 3, in regions opposing the regions of the adhesive material 2 of the back surface. The release material is also coated in stripes, that is, in spaced and strip-shaped plural rows, on the upper surface of the label body 1, which is the indication surface indicating the reduced price, etc. On the upper surface of the label body 1, with reference to FIG. 1A, there are a strip-shaped release region A coated with release material 3 and a strip-shaped non-release region B without the release material 3. The regions A and B are formed alternately in the width direction of the upper surface of the label body 1. On the back surface of the label body 1, with reference to FIG. 1C, there are a strip-shaped adhesive region C coated with adhesive material 2 and a strip-shaped non-adhesive region D without the adhesive material 2. The regions C and D are formed alternately in the width direction. In addition, in the embodiment of the present invention, the strip direction of the coated adhesive material 2, which is the vertical direction shown in FIG. 1A and FIG. 1B will be called the longitudinal direction, and the horizontal direction perpendicular to the longitudinal direction shown in FIG. 1A and FIG. 1B will be called the width direction.

Any materials which are commonly used for labels may be used for the label body 1, like films such as polyester resin, polyethylene resin and polypropylene resin, etc., secondary elaborated films such as nema (metal deposited polyester films) and synthetic papers, and paper materials such as fine quality papers, coated papers, cardboards and impregnated papers, or materials such as gold foils.

For the adhesive material 2, any types of adhesive may be used, for example, emulsion types, solvent types and hot-melt types. As for the material, any type of materials such as acrylic types and rubber types may be used. Also the adhesion strength of the adhesive material may be any type such as strong-adhesion type or soft-adhesion type.

For the release material 3, for example, silicon resin can be used. As for the silicon resin, any of solvent types, non-solvent types or emulsion types may be used. In addition, depending on the material of the label body 1, there may be a sealing layer, such as polyethylene placed and operative for preventing the infiltration of the release material 3 to the label body 1.

In an embodiment, according to FIG. 1C, the adhesive material 2 is coated on the back surface of the label body 1 in three strips of the same width. Two of the adhesive regions C are formed respectively at both ends of the width direction, and the other adhesive region C is formed roughly in the center of the width direction between the non-adhesive regions D. Further, according to FIG. 1A, the release material 3 is coated on the upper surface of the label body 1 in three strips slightly wider than the width of the adhesive regions C. Two of the release regions A are formed respectively on both ends of the width direction of the label body 1 on the opposite side from the adhesive regions C coated on the back surface of the label body 1, and the other release region A is formed roughly in the center of the width direction of the label body 1 between the non-release regions B.

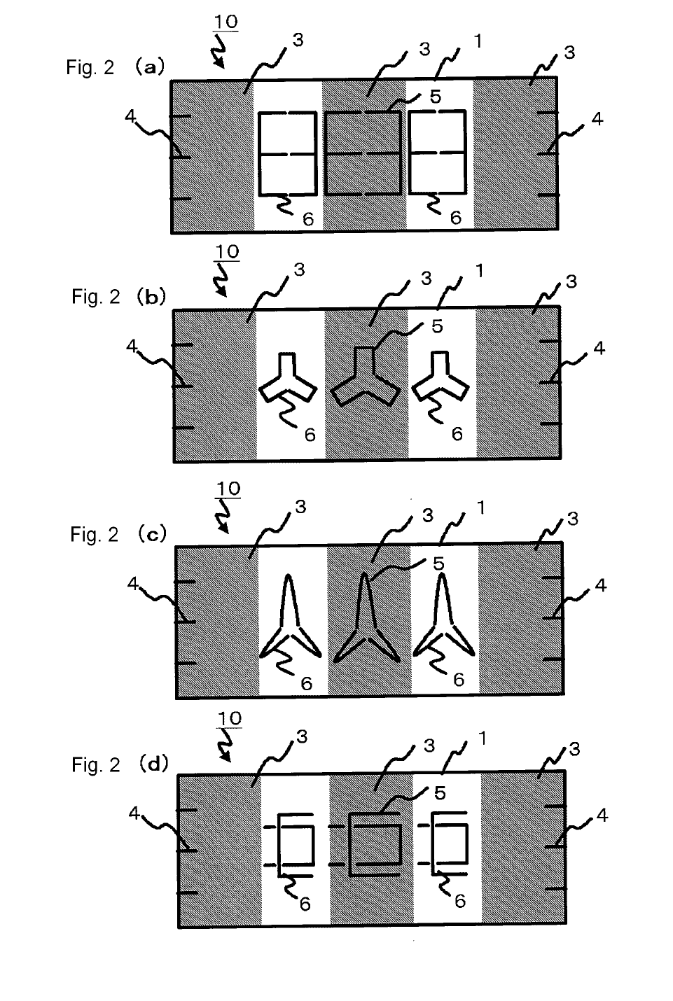

In the adhesive regions C formed respectively on both ends in the width direction of the label body 1, the re-application preventing slits, as the first tamper-resistant slits 4, are formed inwardly from the both ends respectively. In the adhesive region C formed at the center of the width direction of the label body 1, multiple radiating re-application preventing slits are formed as the second tamper-resistant slits 5. Also in the two non-release regions B of the label body 1, multiple radiating re-application preventing slits are formed as the third tamper-resistant slits 6 respectively. In addition, the number and the angle of the first tamper-resistant slits 4 may be suitably arranged. The second tamper-resistant slits 5 and the third tamper-resistant slits 6 may also be suitably arranged and selected, as shown in FIGS. 2A through 2D.

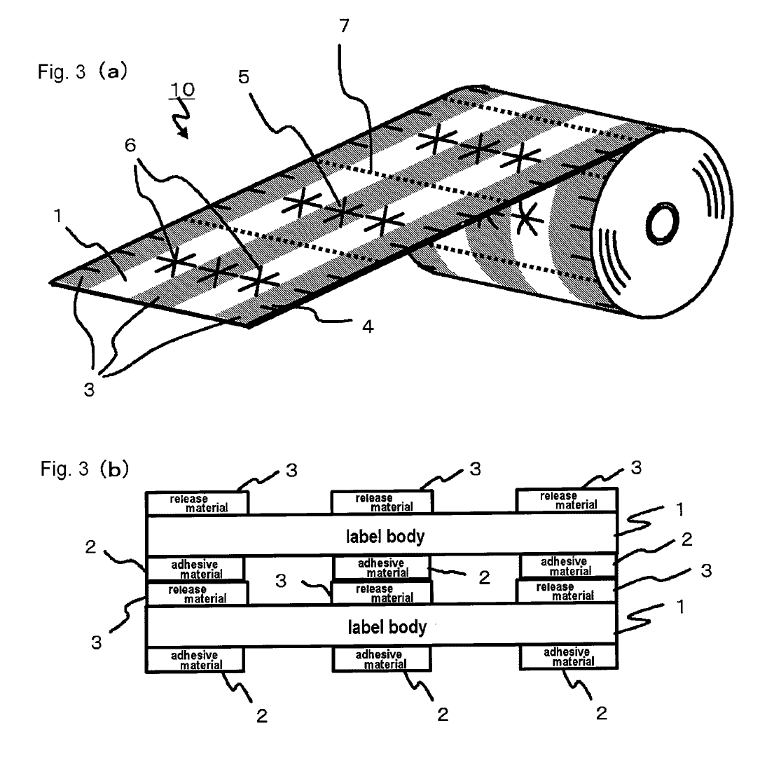

Referring to FIG. 3A, the price reduction label 10 is provided as a continuous label strip extending in the longitudinal direction with cut processing lines 7 such as perforations or micro-perforations between successive labels of the strip. Furthermore, the price reduction label 10 is provided as a label without a backing paper. Without being temporarily applied to a backing paper, the label 10 is wound in a roll with the upper surface of the label body 1 coated with the release material 3 on the outside. When in a wound rolled state, as shown in FIG. 3A, the adhesive materials 2 and the release materials 3 coated on each price reduction labels 10 will locate at the same locations in the width direction. Therefore for the wound and layered price reduction labels 10, as shown in FIG. 3B, the adhesive material 2 coated on the back surface of the outwardly wound label body 1 is temporarily applied to the release material 3 coated on the upper surface of the label body 1. This enables the price reduction label 10 to be removed and pulled off the wound body without tearing of the label at the first tamper-resistant slits 4, the second tamper-resistant slits 5 and the third tamper-resistant slits 6 formed on the label body 1.

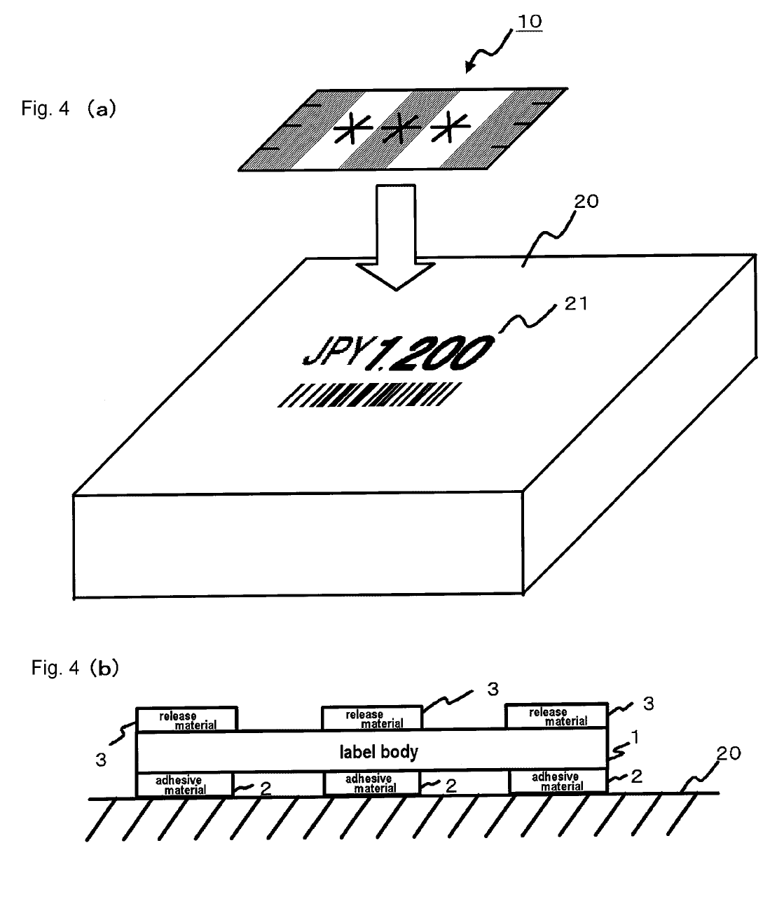

Next, the label applying method of the embodiments will be described according to FIGS. 4 through 6.

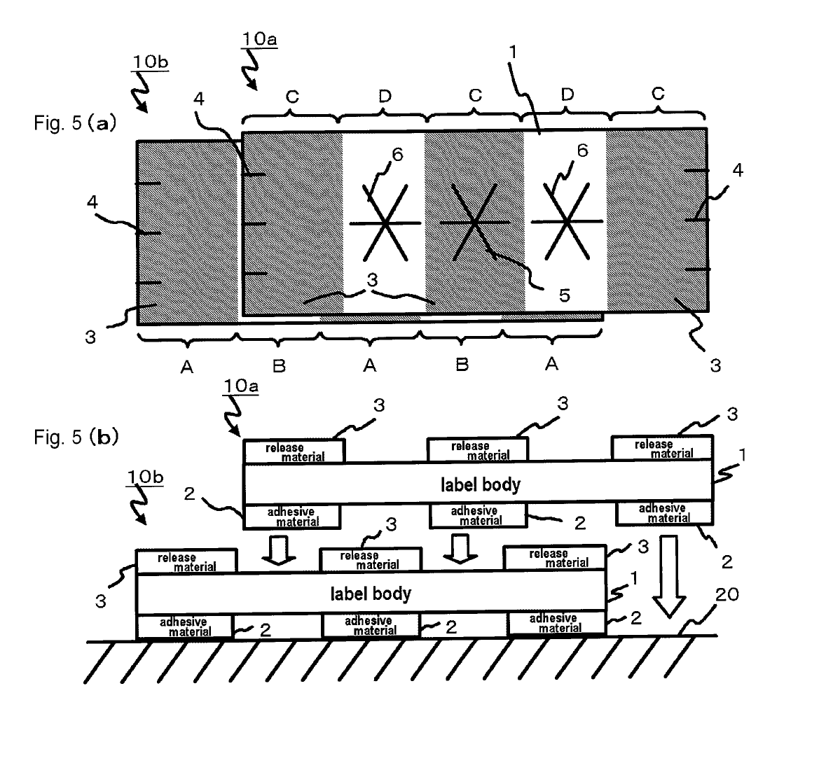

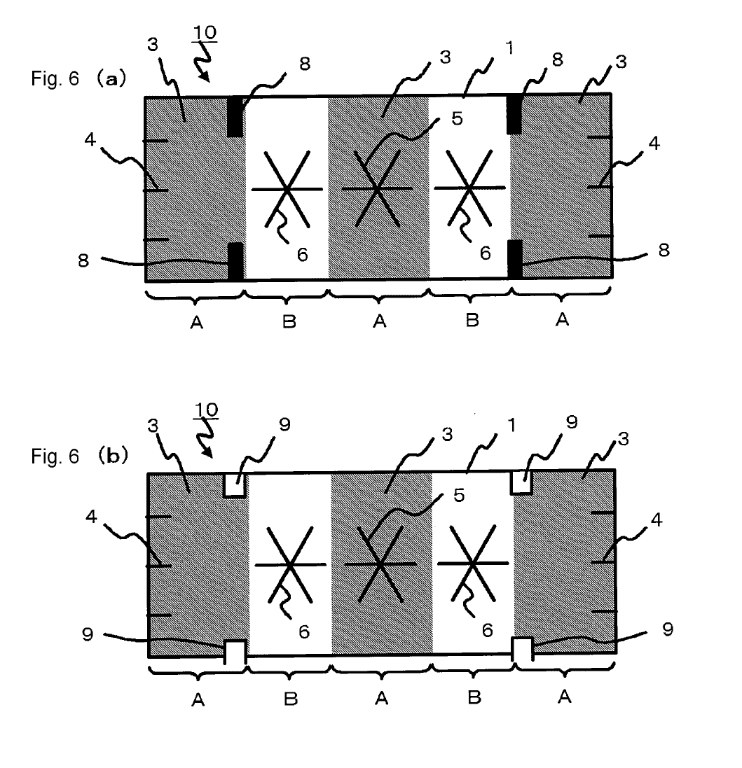

FIGS. 4A and 4B are diagrams describing an applying method for the price reduction label shown in FIGS. 1A to 1C to an article. FIGS. 5A and 5B are diagrams describing the applying method of the price reduction label by applying the price reduction label on top of other labels. FIGS. 6A and 6B are diagrams showing the examples of marks enabling applying one label on top of any other.

Referring to FIG. 4A, when changing the price indication 21 like the price and the bar-code, displayed directly on the articles 20 such as commercial goods, or displayed by ordinary labels without release material coated on the upper surface, the new reduced price and the bar-code (not shown) are applied on the upper surface of the price reduction label 10 by a printer, etc., not illustrated. Then as indicated by the arrow, the price reduction label 10 is applied over the price indication 21 of the article 20. In FIG. 4A, it is configured that a piece of price reduction label 10 is applied over the price indication 21 consisting of the price and the bar-code. In addition, by providing the separation processing lines such as perforations or micro-perforations longitudinally separating the price reduction labels 10 and by separating the price reduction labels 10 from the separation processing lines, the price reduction labels 10 may be applied respectively to the price and the bar-code. In this case, it is possible to deal with a situation when the price and the bar-code are displayed separated.

In this way, as shown in FIG. 4B, the adhesive material 2 coated on the back surface of the label body 1 is applied to the article 20. Therefore when trying to peel off the price reduction label 10 on the article 20, the first tamper-resistant slits 4 and the second tamper-resistant slits 5 formed on the adhesive region C coated with adhesive material 2 are torn, preventing the reuse of the removed price reduction label 10.

Next, when changing the price again after applying the price reduction label 10, according to FIG. 5A, the new price and the bar-code (not shown) are indicated on the surface of the new price reduction label 10 (hereinafter called the new price reduction label 10a), and it is applied over the already applied price reduction label 10 (hereinafter called as the already applied price reduction label 10b) by shifting it in the width direction for the release region A width formed on the ends of the already applied price reduction label 10b. Thereby as shown in FIG. 5B, at least the first tamper-resistant slit 4 portions of the adhesive region C formed on the ends of the width direction of the new price reduction label 10a are applied to the non-release regions B formed on the upper surface of the already applied price reduction label 10b and to the article 20 respectively. Furthermore, by shifting in the width direction for the release region A width formed on the ends of the already applied price reduction label 10b and applying the new price reduction label 10a, the release material 3 coated region of the adhesive region C formed in the center portion on the upper surface of the new price reduction label 10a is configured such that at least the portion formed with the second tamper-resistant slit 5 is applied to the non-release region B formed on the upper surface of the already applied price reduction label 10b. Thereby the adhesive region C formed with the second tamper-resistant slit 5 is applied, as shown in FIG. 5B, to the non-adhesive region B formed on the upper surface of the already applied price reduction label 10b.

Therefore, when trying to remove the applied new price reduction label 10a, as the adhesive regions C of the new price reduction label 10a are applied respectively to the non-release regions B of the already applied price reduction label 10b and to the article 20, the label body 1 of the new price reduction label 10a will be torn by the first tamper-resistant slits 4 and the second tamper-resistant slit 5 formed on the adhesive regions C. Further, the label body 1 of the already applied price reduction label 10b will be torn by the second tamper-resistant slit 5 formed on the non-release regions B of the already applied price reduction label 10b. Thereby preventing the reuse of the removed new price reduction label 10a, and also leaving traces of the removed label on the already applied price reduction label 10b.

In the embodiment, an example of application of the new price reduction label 10a on top of the already applied price reduction label 10b has been described. However, the width direction of shifting the new price reduction label 10a may either be to the right or to the left. Moreover, with the above procedure, several price reduction labels 10 can be applied on top of the other, therefore the price may be changed a number of times.

Furthermore, for the release material 3, transparent materials are commonly used. Therefore, as a reference for applying the new price reduction label 10a shifted in the width direction for the release region A width formed on the ends of the already applied price reduction label 10b, it is preferred to provide, as shown in FIG. 6A, marks 8 indicating the locations of the release regions A formed on the edges of the reduction label 10, and also as shown in FIG. 6B, notches 9 as guides indicating the locations of the release regions A formed on the ends of the reduction label 10.

As described above, according to the present embodiment, provided is a label body 1 with the upper surface working as an indication surface of the new price and a back surface as an applying surface applied to the article 20, an adhesive material 2 coated on the back surface of the label body 1 in spaced and strip-shaped plural rows, a release material 3 coated on the upper surface of the label body 1 opposite the region of the adhesive material 2 of the back surface. An adhesive region C coated with the adhesive material 2 and a non-adhesive region D without the adhesive material 2 are formed alternately in the width direction perpendicular to the strip direction of adhesive material 2 on the back surface of the label body 1, and a release region A coated with release material 3 and a non-release region B without the release material 3 are formed alternately in the width direction of the upper surface of the label body 1. The first tamper-resistant slits 4 and the second tamper-resistant slits 5 are formed on the adhesive regions C of the label body 1. Such that, by winding the label body 1 in a roll with the upper surface of the label body 1 on the outside as a continuous label strip connected in the direction of the adhesive material 2, the adhesive material 2 coated on the back surface of the outwardly wound label body 1 is temporarily applied to the release material 3 coated on the upper surface of the label body 1. Therefore, it can be used as a label without a backing paper. When applying the label on top of another, by applying the new price reduction label 10a shifted in the width direction of the already applied price reduction label 10b for the release region A width, the adhesive regions C formed with the first tamper-resistant slits 4 and the second tamper-resistant slit 5 are applied to the non-release regions B of the already applied price reduction label 10b other than the release regions A, and to the article 20. Therefore, even if applied on top of another label, when the new price reduction label 10a is removed, the label is infallibly torn at the first tamper-resistant slits 4 and the second tamper-resistant slit 5 achieving the effect of preventing the reuse of the label.

Furthermore, according to the present embodiment, by forming the third tamper-resistant slits 6 on the label body 1 of the non-release region B, when applying the label on top of another one, by shifting in the width direction for the release region A width of the already applied price reduction label 10b and applying the new price reduction label 10a, the adhesive region C of the new price reduction label 10a is applied to the non-release regions B of the already applied price reduction label 10b formed with the third tamper-resistant slits 6. So when removing the new price reduction label 10a, the already applied price reduction label 10b is torn at the third tamper-resistant slits 6, resulting in leaving traces of the removed label.

Still furthermore, according to the present embodiment, by providing a mark on the label body 1 indicating the location of the release region A, it achieves easy understanding of how much to shift the label when applying one label on top of another.

In addition, it should be noted that the present invention is not restricted to the above-described embodiments. It can be clearly understood that each of the embodiments may be modified as appropriate without departing from the technical scope of the present invention. Furthermore, the number, the positions, the configurations, etc., of the aforementioned components are not restricted to those in the above-described embodiments. Rather, the number, positions, configurations, thereof can be modified as suitable for carrying out the present invention. It should be noted that, in the drawings, the same components are denoted by the same reference numerals.

1. A label to be applied over a location on an article, the label including:
a label body having an upper surface on which an indication is applied and having an opposite back surface to be applied to the article;
an adhesive material coated on the back surface of the label body, the adhesive material arranged in a plurality of spaced apart, strip-shaped rows; the rows of the coated adhesive material alternate with rows of a non-adhesive region that is without the adhesive material, the rows of adhesive material are formed alternately with the rows of a non-adhesive region in the width direction of and perpendicular to a strip direction of extension of the adhesive material coated on the back surface of the label body, and
a release material coated on the upper surface of the label body, the release material arranged in a plurality of spaced apart strip-shaped rows/on an opposite side of the label from the rows of the adhesive material/on the back surface; the rows of the release material alternate with rows of non-release regions which are without the release material and the rows of release material and non-release regions are formed alternately in the width direction of the upper surface of the label body; and
a label body re-application preventing slit formed in the adhesive region of the label body.

2. The label according to claim 1, wherein the non-release region of the label body includes the re-application preventing slit.

3. The label according to claim 1, wherein the label body has a mark indicating the location of the release region.

4. A method of applying a label according to claim 1 by applying a new one of the labels on top of another of the labels, the method comprising shifting the new label in the width direction so that the release region in the width direction of the new label is applied over the label applied on the article, and the adhesive region of the new label is applied over the non-release region of the other label applied on the article.

5. The label according to claim 1, further comprising at least one of the reapplication preventing slits in at least one of the release regions and the non-release region of the label body.

6. A label assembly comprised of a first one of the labels of claim 1 on an article and a new one of the labels of claim 1 applied over the first one of the labels, wherein the new label is applied with the adhesive strips of the new label applied over the non-release region of the first one of the labels.

7. The label according to claim 1, wherein the rows of the adhesive material and the rows of the release material are positioned at overlying locations in the width direction on their respective upper and back surfaces of the label.

8. The label according to claim 1, wherein the label is a price reduction label and the indication on the upper surface concerns a price reduction of an article on which the label is applied.
